(19) United States
(12) Patent Application Publication
(10) Pub. No.: US 2006/0138768 A1
(43) Pub. Date: Jun. 29, 2006

(54) All-in-one photographic letter stationery and envelope

(76) Inventors: Alejandre Alova Abaygar, Panorama, CA (US); Arthur James Angeles Abaygar, Paranaque (PH); Anne Christine Angeles Abaygar, Paranaque (PH)

Correspondence Address: ALEJANDRE A. ABAYGAR, 1744 W. CHAPMAN AVE., ORANGE, CA, 92868, US

(21) Appl. No.: 11/296,839

(22) Filed: Dec. 6, 2005

Related U.S. Application Data
(60) Provisional application No. 60/635,362, filed on Dec. 9, 2004.

(51) Int. Cl. B42D 15/00

(52) U.S. Cl. 283/106

(57) ABSTRACT

This is an innovative, uniquely original and multi-functional article for postal mail correspondence which incorporates in a single, basically rectangular sheet of paper (11), the features and functions of a stationery, a multiple-picture postcard and an envelope, with central sections (12) and side sections (13) that can be written on as a stationery or writing pad, showing a plurality of photographs 16 (preprinted and additionally, user-provided) which, when properly folded and sealed using its pre-glued top flap (14), bottom flap (14A) side flaps (24), or commonly available glued strips, transforms into a completely sealed envelope ready for posting in the mail, or sent by courier services. This is an entirely new product that serves for all types of mail correspondence, be it personal, business, institutional, etc, the only one of its kind and a new product category by itself. As an added optional service feature, the postage can be prepaid by prior arrangement and collaboration with the postal authority of jurisdiction, thereby making this invention ready for mailing, giving added convenience to the user who need not make a separate stamp purchase. While this invention is susceptible of embodiment in many different forms, there is shown in the drawings and will herein be described in detail the preferred embodiments of the invention with the understanding that the present disclosure is to be construed as an exemplification of the principles of the invention and is not intended to limit the invention to the embodiments illustrated.

### CROSS REFERENCE TO RELATED APPLICATIONS

This application claims the benefit of Provisional Patent Application Ser. No. 60/635,362 filed Dec. 9, 2004 by the present inventors.

### FEDERALLY SPONSORED RESEARCH

Not Applicable

### SEQUENCE LISTING OR PROGRAM

Not Applicable

### BACKGROUND OF INVENTION

1. Field of Invention

This invention relates to articles used for postal correspondence, primarily for letter writing and correspondence using the conventional postal mailing and courier services.

2. Prior Art

In current practice, there are distinct products used for writing letters and notes, the stationery; another product for sending a photograph with very minimal notes, the postcard; and still another product for enclosing the letter for privacy and mailing, the letter envelope.

All of these products are different from and functionally separate from each other. People normally use the stationery for writing, typing or printing their letters and correspondences. These stationeries typically do not contain any photograph, much less photographs of any given theme, subject or area of interest. The postcard on the other hand is mainly an open card showing typically one photograph and in some cases, a collage of a few photographs, on one side and a very limited space for a few notes on the other side where the designated space for the sender's and the addressee's addresses, as well as the postage stamp are also placed. The envelope is really just that, to enclose or contain letters and ensure their privacy while in transit from the sender to the addressee or recipient. What this invention has is the functional integration of all of the three products into a single item, while still offering superior or at least the same comparative functionalities as the other three, with much greater aesthetic appeal and other desirable features that will be discussed in other sections of this patent application.

3. Objects and Advantages

The combination of both the physical design and functional utilitarian format of this invention has the following objects and advantages:
1. To provide an article used for postal mail correspondence that offers several functions in only one sheet of paper: a letter stationery, a multiple-photograph postcard, and an envelope, all combined into one product, the subject of this invention.
2. To provide an article for postal mail correspondence that is superior to the conventional letter stationery in that it has a plurality of photographs that add interest and appeal to both the user and the recipient.
3. To provide an article for postal mail correspondence that is superior to the conventional postcard in that it has a plurality of photographs, more than what is presented in the currently available postcards.
4. To provide an article for postal mail correspondence that, in addition to already being a stationery with multiple photographs, also folds into an envelope providing all the basic privacy to its contents as that of the commonly available envelopes.
5. To provide an article for postal mail correspondence that is economical to produce in that it effectively replaces three separate and distinct products.
6. To provide an article for postal mail correspondence that can optionally offer a greater degree of convenience to the user by presenting a ready to mail product, in the particular case where the postage is prepaid through prior arrangement and collaboration with the postal authority of jurisdiction.
7. To provide an article used for postal mail correspondence that serves as a promotional tool for the objectives of various institutions such as, but not limited to national, state, city and other political jurisdictions, including governmental and non-governmental organizations, educational, military, professional organizations, etc.
8. To provide an article for postal mail correspondence that can be utilized for tourism promotions by nations, states, counties, cities, municipalities, etc.
9. To provide an article for postal mail correspondence that can be utilized for educational, public relations and promotional purposes by educational institutions such as universities, colleges, etc., while being used primarily by their respective students, faculty and the public.
10. To provide an article for postal communications that can be utilized for promotional and goodwill purposes by such organizations as the military services, unions, professional associations, etc., while being used primarily by their members, affiliates and associates.
11. To provide an article for postal mail correspondence that can be utilized for commercial and advertising purposes by commercial, business institutions such as, but not limited to hotels, resorts, amusement parks, malls, etc, while being used primarily by their customers, guests, visitors, etc.
12. To provide an article for postal mail correspondence that can be utilized by business enterprises for the promotion of their products and services while being used by their employees, staff, associates, etc.

While the present need for writing pad/stationery, postcard and envelope are already being met by various products in the market today, there is none that incorporates all of the above elements into only a single product, such as this invention: the functionally integrated “All-in-One Photographic Letter Stationery and Envelope” also referred to herein as the Photo-Stationery, the subject of the appended claims.

By the combination of physical design and functional utilitarian format, this invention, the Photo-Stationery, is providing an economical, aesthetically pleasing product that serves the triple functions of a letter stationery, multiple-picture postcard and envelope, all in one sheet of paper, with double sided printing, constituting into a uniquely original, versatile product. This is the first and only product of its kind.

### SUMMARY OF THE INVENTION

This invention, the All-in-One Photographic Letter Stationery and Envelope, also herein referred to as Photo-Stationery, is an innovative invention, a uniquely original improvement on existing products, with the following essential features and attributes:
a) It serves as a stationery or writing pad, it contains several photographs and/or artistic graphic works, similar to yet better than a simple post card,
b) When properly folded and sealed as an envelope, it ensures the privacy of its content, as any conventional envelope, which can then be sent by mail or appropriate courier services, like an ordinary letter.
c) It is economical in that it maximizes the use of paper materials, while providing the practical convenience of using only one sheet with double sided printing, by fully integrating and adequately serving the functions of three (3) traditionally separate and distinct products, the stationery/note pad, post card and envelope, into a single product.
d) The combination of practicality, functionality and aesthetic design into a completely new product, a category by itself, will stimulate and encourage the use of the traditional mailing service and will inevitably increase postal revenues. It can also be used for institutional, promotional purposes to and for its members and patrons.
e) As an optional, added service feature which requires prior arrangement or collaboration with the proper postal authority of jurisdiction, the postage for the photo-stationery can be prepaid, thus making it ready for immediate mailing, without the user having to separately purchase stamps. It will, in effect, be a new postal product by itself, which when incorporated with prepaid postage stamps, can further add convenience to the writing public.

### DRAWINGS

FIG. 1 Perspective view of a typical photo-stationery

FIG. 2 Flat view of the typical internal side of the photo-stationery

FIG. 3 Flat view of the typical external side of the photo-stationery

FIG. 4 Flat view of a typical expanded design version of the photo-stationery showing 3 to 4 central sections.

FIG. 5 Flat view of another design version of the photo-stationery showing 2 or more central sections, with a top flap.

FIG. 5A Same as FIG. 5, but with a bottom flap.

FIG. 6 Flat view of the simplest design version of the photo-stationery showing 2 central stations, with no side flaps

FIG. 6A Expanded design version as shown in FIG. 6 with additional central section.

### REFERENCE NUMERALS

11 rectangular shaped photo-stationery
12 central section primarily for the user's written, typed or printed text
13 side flap section for pre-printed photographs/graphics/artworks.
14 small top flap with strip of dried glue or paste.
14A small bottom flap with strip of dried glue or paste.
14B strip of dried glue or paste
15 user's written text
16 pre-printed photographs/graphics artworks
16A insertion slit for optional insertion of photographs.
17 sender's name and postal address
18 addressee's name and postal address
19 marked box space for postage stamp
20 title/theme of the photo-stationery
21 front cover photograph
22 brief descriptive title text
23 additional central section for the user's notes and/or additional photos & graphics
24 short, narrow side flap with strip of dried glue or paste

### DETAILED DESCRIPTION

While this invention is susceptible of embodiment in many different forms, there is shown in the drawings and will herein be described in detail preferred embodiments of the invention with the understanding that the present disclosure is to be construed as an exemplification of the principles of the invention and is not intended to limit the invention to the embodiments illustrated.

The FIG. 1 drawing shows a basically rectangular shaped stationery 11 divided into two central sections 12 with space designated primarily for the written text 15; two side flap sections 13 for pre-printed photographs, graphics or decorative artwork 16. These side flaps 13 are folded vertically inward, after which the central sections 12 can be folded horizontally. The small top flap 14 on the uppermost section has a strip of dried glue or paste 14B, such that when the stationery is folded, the glue strip 14B is moistened and the flap is closed over the folded main sections, it is transformed into a sealed envelope which conceals its written sections and ensures the privacy of any other written or printed material that may be placed inside it. In another design variation, a bottom flap 14A may also be used in lieu of the top flap 14.

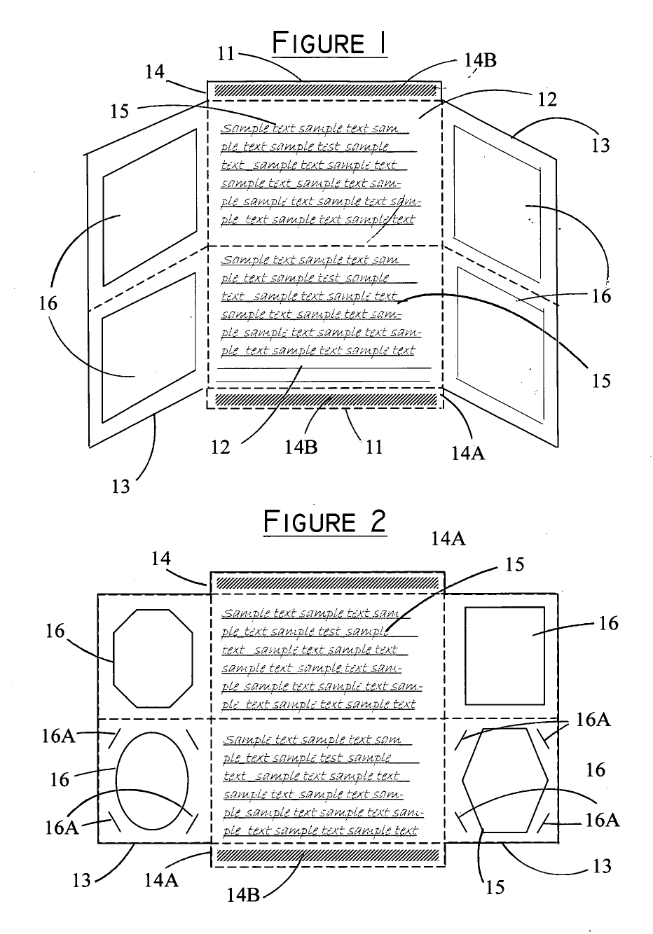

The FIG. 2 drawing shows the typical design layout of the internal side of the photo-stationery with designated area in the central section 12 for the user's written text 15 (this space can be either left blank, or provided with ruled lines which serve as writing guides), as well as two side flap sections 13 for pre-printed photographs, graphics or art works 16. The user can also choose to either paste on or insert his/her own photographs on said designated spaces. Small insertion slits 16A at appropriate locations may be optionally provided to facilitate easy insertion and removal of photographs by the user. The layout arrangements on the positioning of the user's written, typed or printed text 15 and the photos/graphics or artworks 16 may be varied artistically for variety, while maintaining its overall aesthetic appeal.

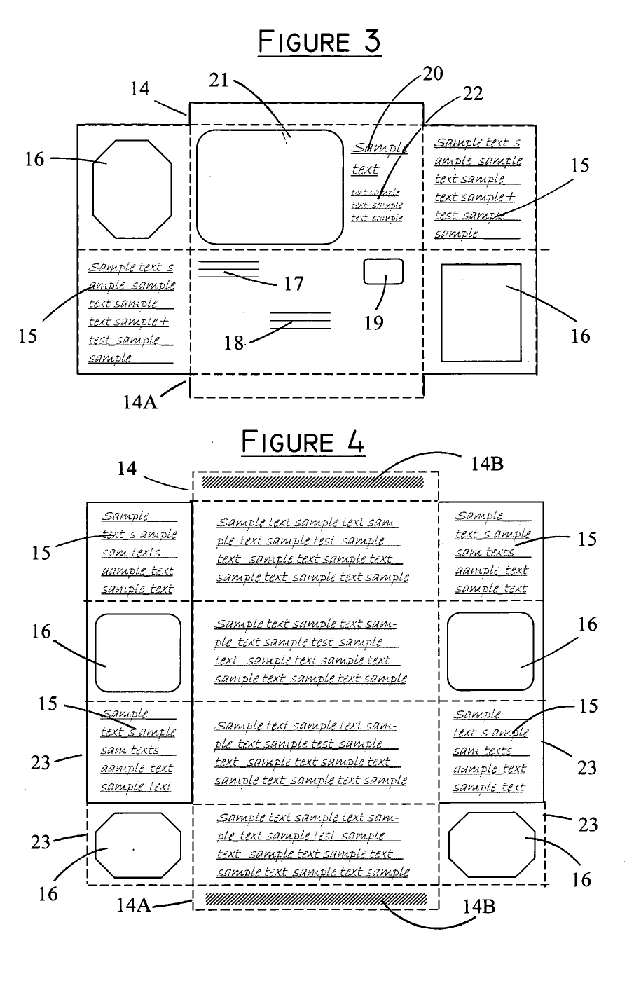

The FIG. 3 shows the typical design layout of the external side of the photo-stationery with the exposed front section, which contains the sender's name and postal address 17, the addressee's name and postal address 18 and the box marked location for the postage stamp 19; the exposed back section has the pre-printed stationery title 20, the cover photograph 21 and the brief descriptive text 21; the side flap sections 13 have pre-printed photographs/graphics/art works 16, or alternately, space for the user's written, typed or printed text. 15.

The FIG. 4 shows a variation in the physical design and dimensions of the photographic stationery typifying the expanded versions of this invention, where a bigger, longer paper is used, thus providing an additional section 23 in order to have three (3) main sections, instead of the standard two (2) sections. Additional sections 23 if desired, can be accommodated by using a proportionately longer paper that can accommodate four (4) or more sections as may be desired. The layout arrangements for the external and internal sides of the photo-stationery having all the said elements as detailed in FIG. 2 and FIG. 3 would be correspondingly modified to fit the physical dimensions of the design variation.

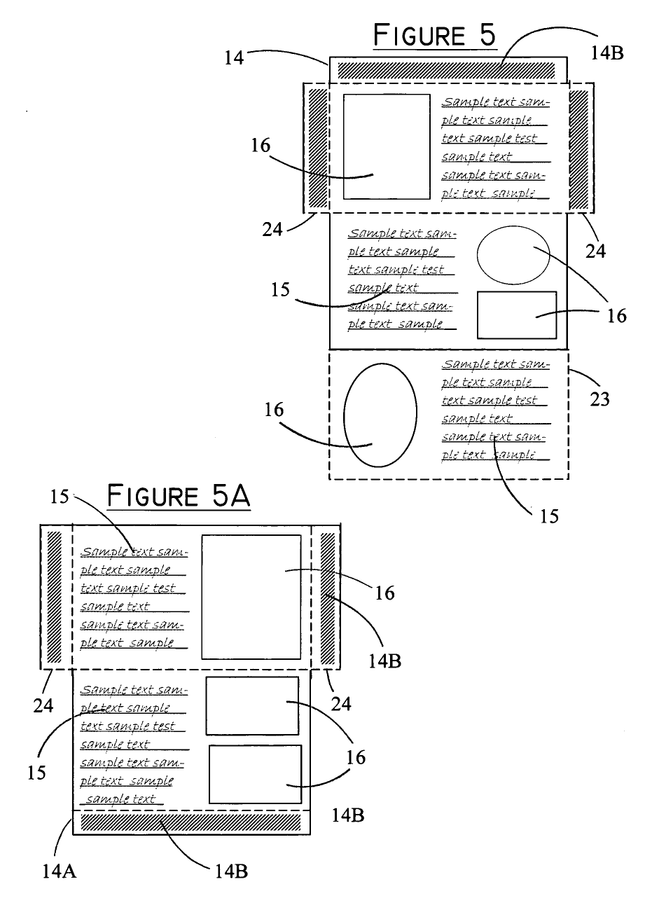

FIG. 5 shows a variation in the physical design and dimensions of the photo-stationery, using smaller size paper with short, narrow side flaps 24 which do not have space for either text 15 or photographs/graphics/artworks 16. These side flaps 24 have strips of dried glue or paste 14B, the same as the topmost flap 14. This design can still have expanded central sections 12 of two or more sections, as may be desired. The layout arrangements for the external and internal sides of the photo-stationery having all the said elements as detailed in FIG. 2 and FIG. 3 would be correspondingly modified to fit the physical dimensions of the design variation.

FIG. 5A shows another variation in the physical design of the photo-stationery as shown in FIG. 5, with a bottom flap 14A instead of the top flap 14. The layout arrangements for the external and internal sides of the photo-stationery having all the said elements as detailed in FIG. 2 and FIG. 3 would be correspondingly modified to fit the physical dimensions of the design variation.

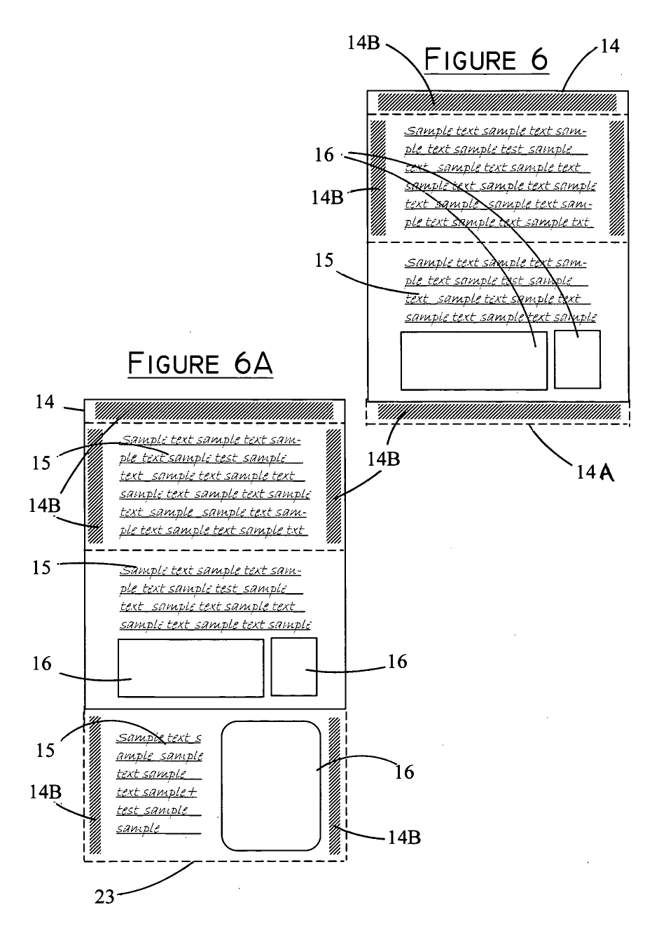

FIG. 6 shows the simplest design of the photo-stationery, with two central sections 12 containing designated spaces for written, typed or printed text 15 and photos/graphics or art works 16; with either a pre-glued top flap 14 or bottom flap 14A, with or without additional pre-glued strips 14B at its side edge, to ensure a complete seal. The layout arrangements for the external and internal sides of the photo-stationery having all the said elements as detailed in FIG. 2 and FIG. 3 would be correspondingly modified to fit the physical dimensions of the design variation.

FIG. 6A shows the expanded version of the simplest design of the photo-stationery as described in FIG. 6 with two central sections 12 and an additional section 23 containing designated spaces for written, typed or printed text 15 and photos/graphics or art works 16; with a pre-glued top flap 14, with or without additional pre-glued strips 14B at its side edge, to ensure a complete seal. The layout arrangements for the external and internal sides of the photo-stationery having all the said elements as detailed in FIG. 2 and FIG. 3 would be correspondingly modified to fit the physical dimensions of the design variation.

The paper to be used for this innovative, uniquely original and multi-functional Photo-Stationery shall be of suitable material of the appropriate substance (thickness), with an appropriate finish, whether regular, matte, semi-glossy, glossy or textured finish, of the appropriate size that can accommodate a minimum of two sections in a double fold, and with expanded versions having a plurality of three or more sections with as many folds. The short, narrow side flaps 24, the top flap 14 and bottom flap 14A, with strips of dried glue or paste 14B can be folded to seal the Photo-Stationery. In design versions with no flaps, separate commonly available paste-on strips or conventional office tape may also be used.

The large side flap sections 13 shall be of varying sizes to provide space for photographs, graphics artworks 16 and the user's written, typed or printed text 15, but for practical considerations may be nearly as large as, but not larger than the central section 12 of the Photo-Stationery.

In design variations where small side flaps 24 are used, these flaps shall be small and narrow but adequate enough to provide sufficient flap cover and sealing when the Photo-Stationery is closed and sealed. In this case, the size of the small side flaps 24 may ideally be the same as that of the small top 14 or bottom flap 14A.

This innovative, uniquely original and multi-functional article for postal correspondence will have pre-printed photographs and artistic graphic artworks 16 that depict places, people, nature, man-made structures, entertainment, flora and fauna, food, as well as institutions, organizations, etc., with or without an underlying promotional objective or theme that is intended to appeal to prospective users. The users however have the option to also insert or paste their own photographs in order to personalize the photo-stationery.

### CONCLUSIONS, RAMIFICATIONS AND SCOPE

Accordingly, the reader will clearly see the superior benefits and features offered by this innovative article for postal mail correspondence:
It is an all-in-one product containing in a single sheet of paper the essential elements of a letter stationery for writing letters enhanced in interest and appeal by pre-printed photographs of a wide variety of subjects that may or may not have a common theme.
It is superior to an ordinary postcard in that it presents a plurality of photographs instead of being limited to one or at most very few.
It can be used as an effective promotional and educational tool on the chosen subject or theme of the photo-stationery.
It is a completely new product that will stimulate and encourage the use of postal mail correspondence and thereby increase the revenues of the postal authorities.

While the present peed for writing pad and stationery, postcard and envelope are already being met by various products in the market today, there is none that incorporates all of the above elements into only a single product such as this invention, the functionally integrated all-in-one photographic letter stationery and envelope, also referred to herein as the Photo-Stationery, which is the subject of the appended claims.

By the combination of physical design and functional utilitarian format, this invention, the Photo-Stationery, is providing an economical yet aesthetically pleasing product that serves the triple functions of a letter stationery, a multi-picture postcard and an envelope, all in one sheet of paper with double sided printing constituting into a uniquely original, versatile, multi-functional product. This is the first and only product of its kind.

Although the above description contains many specifications, these should not be construed as limiting the scope of the invention but as merely providing illustrations of some of the presently preferred embodiments of this invention. For example, the photo-stationery can have a wide variety of design versions, layouts, shapes and sizes, having as many sections as practicable, etc.

The scope of the invention should be determined by the appended claims and their legal equivalents, rather than by the examples given.

What is claimed is:

1. An article for postal mail correspondence that is innovative, uniquely original and multi-functional in that using only one sheet of paper of the appropriate size and shape, with printing on both sides, it serves the triple functions of a) a letter stationery or writing pad, b) a multiple-picture post card, and c) an envelope, so shaped and designed in such a way that this single sheet of paper is divided into a plurality of two or more horizontal and vertical sections with the following design elements:
a. The internal side, which when folded is hidden from outside view, has designated spaces with or without ruled line guides for use by the letter writer for handwritten, typewritten or printed notes, and complemented with artistically laid out printed photographs and/or graphic artworks showing a wide variety of scenes of interest.
b. The external side, which when folded has two of its sections exposed to outside view one section of which contains the photo-stationery title, the cover photograph with or without graphic artwork, the text description of the photo-stationery's main theme or subject of interest, the mailing information section with designated spaces for the names and addresses of the sender and the addressee; the postage stamp and for the expanded design versions, has additional folding sections for more writing space and photographs.
c. Large side flap sections with designated space for additional writing space for photographs, graphics and or art works, which when folded inward further assures the privacy of the photo-stationery envelope's inside section and all its contents.
d. The pre-glued top or bottom flaps have a strip of dried glue or paste which when moistened or its protective sheet is removed and the flaps are folded inward, will further seal and ensure the privacy of the contents therein.
whereby the said elements combine together in a single sheet of paper that becomes the innovative, uniquely original and multi-functional article for postal mail correspondence.

2. An article for postal mail correspondence that is innovative, uniquely original and multi-functional using only one sheet of paper as defined in claim 1, which in its simple and basic design variation has shortened, narrow side flaps or ears with strips of dried glue so that when the photo-stationery is folded, the said side flaps can be closed and sealed ensuring the privacy of the contents therein, with or without additional top or bottom flaps for more complete seal.

3. An article for postal mail correspondence that is innovative, uniquely original and multi-functional using only one sheet of paper as defined in claim 1, which in its simplest design variation has no side flaps and instead utilizes commonly available paste on strips or alternately pre-glued strips along its side edges as side sealers to ensure closure and privacy of its contents.

4. An article for postal mail correspondence that is innovative, uniquely original and multi-functional using only one sheet of paper as defined in claim 1, which shows a plurality of photographs that depict a wide variety of scenic, aesthetic, artistic views such as, but not limited to, the following types, subjects, categories or themes:
a. Natural places such as mountains, seas, caves, islands, rivers, lakes, forests, including all types of flora and fauna, marine life, etc.
b. Places of significance such as natural parks, historic sites, schools, churches, prominent landmarks, tourist destinations, amusement parks, of various countries, states, counties, cities, municipalities, etc.
c. Man-made infrastructures, equipment and facilities such as gardens, parks, buildings, machines, tools, equipment, housing, commercial and recreational facilities, transport systems, etc.
d. Works of art such as paintings, drawings, sculptures, statues, murals, artifacts from ancient to modern origins, and of various ethnicities and cultures.
e. People and their activities such as sports, recreation, leisure, profession, social-cultural traditions and events, celebrations, etc, and including prominent personages in civic, educational, social, cultural, historical, religious, political, military, scientific and entertainment fields of endeavor, etc.
f. Institutions such as clubs, associations, unions, civic, social, religious, military, government and non-government organizations, including business commercial entities, etc., as may be also represented by their seals, symbols, flags, emblems, etc.

5. An article for postal mail correspondence that is innovative, uniquely original and multi-functional using only one sheet of paper as defined in claim 1, in varied, pleasing and aesthetically appealing design layouts, utilizing a plurality of the said photographs that preprinted and additionally as an option, user-provided, graphic artworks, of different sizes, in color and/or black and white, in varying arrangements, that may or may not highlight special occasions, events and seasonal celebrations, with or without an underlying theme and purpose, with or without any commercial or promotional objective, all of which are designed for artistic, aesthetic appeal to the intended users and their intended recipients.

6. An article for postal mail correspondence that is innovative, uniquely original and multi-functional using only one sheet of paper as defined in claim 1 using paper, paper board, and other suitable materials used for stationeries, of the appropriate substance, i.e. thickness, of suitable finish, ranging from regular, to matte, glossy, semi-glossy, or textured finish, and of the appropriate sizes that would provide a minimum of two central sections on a double fold, or in its expanded versions, a plurality of three or more sections, with as many folds, there by accommodating more writing spaces and photographs.

7. A means for facilitating convenience in postal mail correspondence by utilizing an article for postal mail correspondence that is innovative, uniquely original and multi-functional using only one sheet of paper as defined in claim 1, in which as an added, optional, conditional service feature subject to the prior approval of and collaboration with the proper postal authority of jurisdiction, the postage is prepaid, such that there is no further need for the user to purchase stamps, and thereby providing added convenience to the user.

8. An article for postal and mail correspondence that is innovative, uniquely original and multi-functional using only one sheet of paper as defined in claim 1, as described and shown in the attached drawings.
